(19) United States
(12) Patent Application Publication
(10) Pub. No.: US 2007/0180034 A1
(43) Pub. Date: Aug. 2, 2007

(54) Method and system for filtering communication

(76) Inventors: John DiTroia, Tyngsborough, MA (US); John Charles, Charlotte, NC (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 11/347,729

(22) Filed: Feb. 2, 2006

(51) Int. Cl. G06F 15/16

(52) U.S. Cl. 709/206

(57) ABSTRACT

Receipt and review of unwanted e-mail messages is curtailed by requiring acceptable e-mail messages to include a special indicator specific to the recipient. The recipient system processes incoming messages to search for the specific indicator. Messages that include the specific indicator are provided to the recipient for review. Messages which do not include the indicator are placed in a “bulk” message directory.

### FIELD OF THE INVENTION

The present invention relates to computer systems, and more particularly to the reception of communication over computer networks.

### BACKGROUND OF THE INVENTION

Receiving e-mail from unknown sources wastes time and other valuable resources. Electronic message communication has become a prevalent, and perhaps preferred, method of communication. Such communication is apparent in most aspects of daily life including the workplace, the home, and even the road. At the workplace, the messages may arrive from clients, partners, customers, or other employees. Additionally, at the workplace, messages arrive from friends, acquaintances, and unknown parties. The circumstances are similar for the home user where messages are received from friends, acquaintances, and unknown parties. Reviewing messages consumes time, which may be highly valuable in the case of workplace time. Accordingly, there is a need for a method that reduces the number of messages users receive from unknown sources.

### SUMMARY OF THE INVENTION

Accordingly, the present invention introduces the use of a Personal Mail Identifier (PMI) which is part of a method for attaching personally identifiable information to electronically distributed communication, usually, though not necessarily exclusively, via e-mail. The presence of a PMI in an e-mail message provides reasonable assurance to the recipient that the message is from a legitimate source.

The PMI is preferably provided in a readily identifiable form which can be verified by a human recipient. Such readily identifiable formats include graphics images or pictures, and text or phrases which has meaning to the recipient.

The method of the invention serves as a first line of defense to provide easy identification and segregation of mass mailings commonly referred to as SPAM and the more malicious Phishing attacks from those of legitimate or known origin containing the PMI.

In one embodiment the recipient system validates that the origin of the e-mail is legitimate if the PMI phrase matches that which was configured by the recipient previously. The existence of a valid PMI provides reasonable assurance that the e-mail content, including all hyperlinks, embedded programs, plug-ins, etc. can be treated with a level of confidence normally ascribed to that sender or to that PMI, if more than one PMI is associated with the recipient user.

### BRIEF DESCRIPTION OF THE DRAWINGS

FIG. 1 illustrates a network arrangement, which includes a gateway server operating in accordance with the invention;

FIG. 2 is a flow diagram illustrating a method for distributing a PMI to multiple potential senders; and

FIG. 3 is a flow diagram illustrating a method for processing incoming messages by a recipient computer implementing a method of the invention.

### DETAILED DESCRIPTION OF THE INVENTION

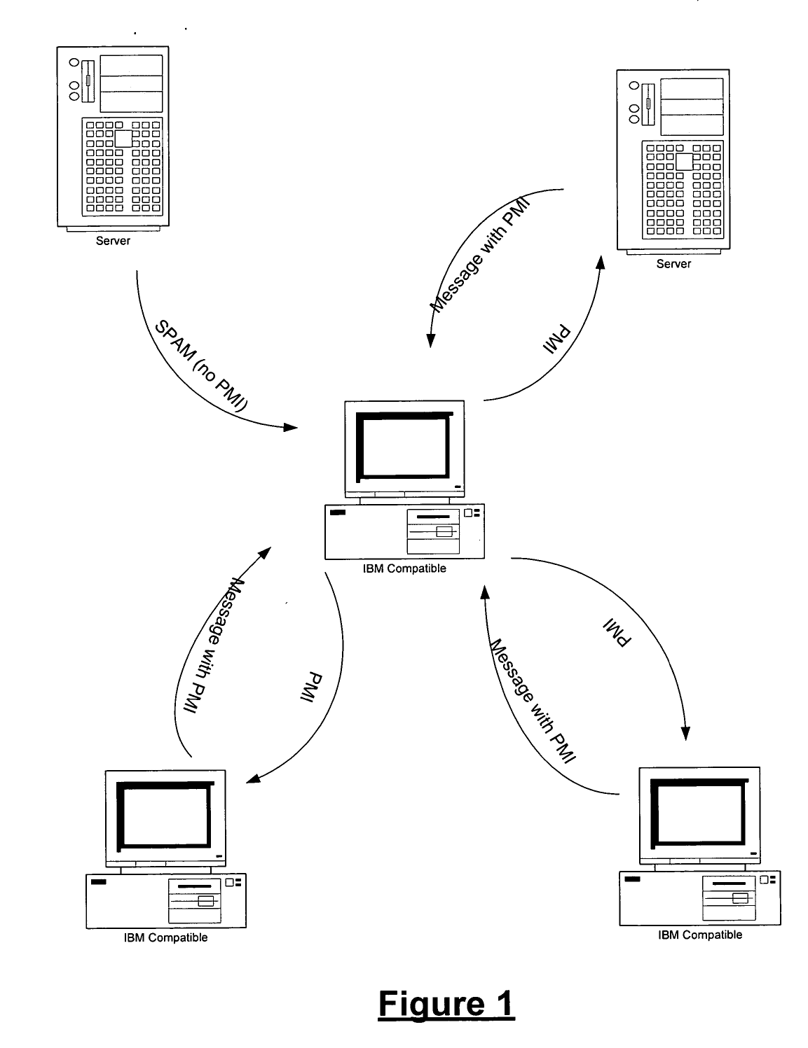

FIG. 1 illustrates message flow between a recipient computer employing the method of the present invention and several sender systems, including both known and unknown user systems and messaging servers. The recipient computer is associated with at least one PMI. As discussed below, the PMI is used to easily and efficiently distinguish between solicited and unsolicited communication. A PMI generally contains one or more identifiers that sufficiently randomize an electronic delivery such that it is easily distinguishable from mass deliveries.

To initiate solicited, or desirable, communication, a sender should include the recipient's PMI in the message. The recipient system searches the message for the PMI to determine whether the message is desirable or unsolicited SPAM. If the PMI is located, the message is deemed desirable and is moved to a “Clean” mailbox, for example. The PMI is provided to a sender by various methods, including direct transmission, intermediary (website) transmission, and in response to an unsolicited request. In the embodiment of FIG. 1, the PMI is directly transmitted to the sender system. For example, a PMI is transmitted to a first and a second user system. Additionally, the PMI is transmitted to a server system from which the user desires to receive message. Such server can include a news service or other mail information subscription service.

Each sender having the recipient's PMI composes a message intended for the recipient. Once configured, all future correspondence originating from that organization will (or should) contain the PMI. When receiving e-mail, the recipient system identifies legitimate e-mail by the incorporation of a valid PMI. The recipient's PMI is embedded in messages transmitted to the recipient system. In one embodiment, the PMI is a text phrase that is included in the message “Subject” field. In another embodiment, the PMI is included in the message body or attachment fields. In some embodiments, the PMI is an encoded data item such as an image or encrypted certificate signature. Accordingly, messages that include the recipient PMI are transmitted to the recipient as well as messages that do not include the recipient PMI. The recipient system then processes the messages by reference to any PMI embedded in each message. In one form, the recipient can manually verify the PMI by simply observing the PMI, which is readily distinguishable from other characters or graphics associated with incoming mail messages. In another embodiment, the identification is automated and is performed by the recipient system.

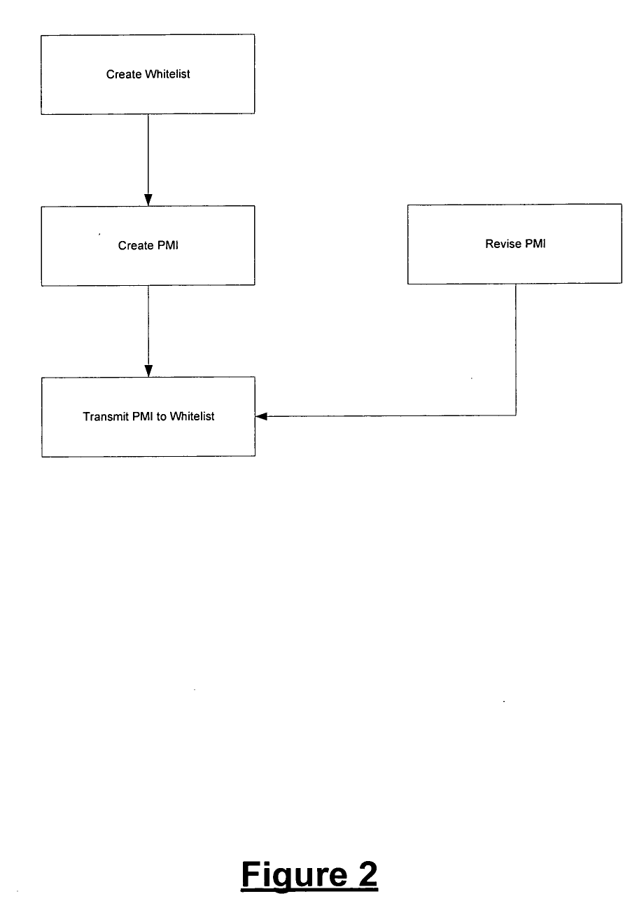

FIG. 2 illustrates a method for publishing a PMI for a user. A user creates a whitelist that includes network identifiers for systems from which the user would like to allow content reception. The user then creates a PMI by either directly entering a text string or employing a program which creates a hash from user information. The generated PMI is then transmitted to the network addresses in the whitelist. When the PMI is revised by the user, for example to prevent fraudulent use, the new PMI is transmitted to the network addresses in the then current whitelist.

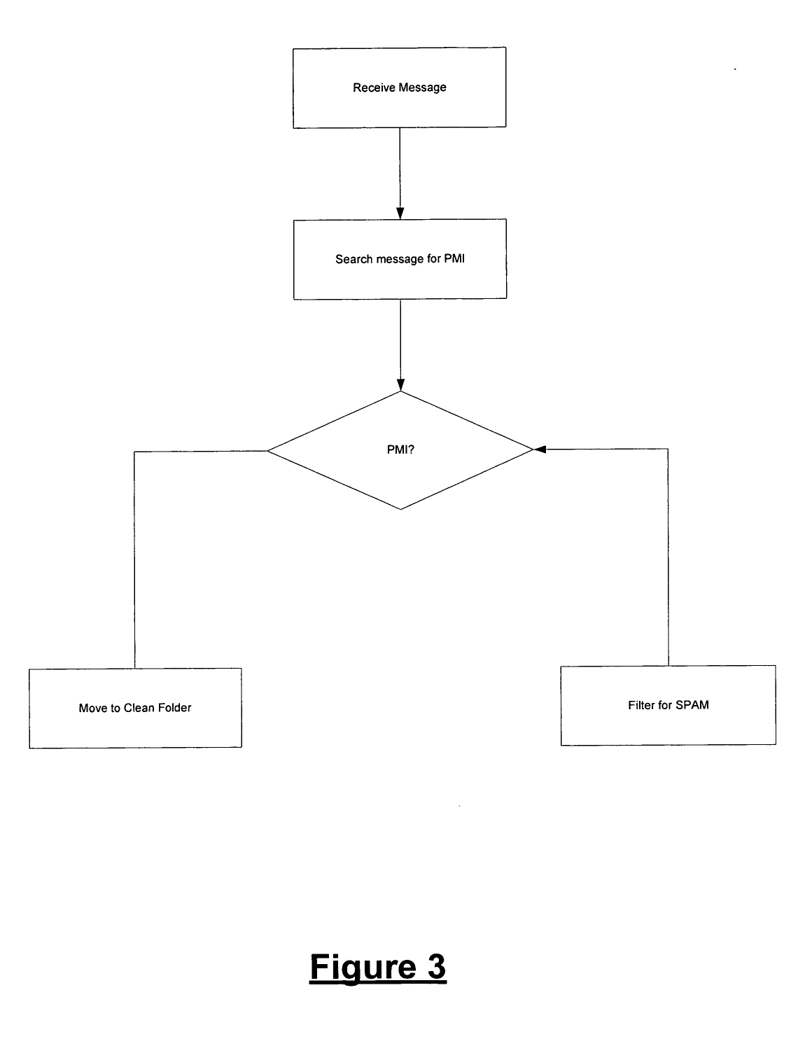

FIG. 3 illustrates a method for processing received e-mail messages in accordance with the invention. A message is received by the e-mail program of a user system. In one embodiment, such message is received by a mailbox associated with the user on a mail server, which serves the user system. An automatic program of the mail server preferably retrieves at least one PMI associated with the recipient corresponding to the mailbox or user system. The program executes instructions which search the message fields for a valid PMI associated with the recipient user. If a valid PMI is detected, one that is associated with the recipient user, the message is moved to a clean folder. If a valid PMI is not detected, the message is preferably moved for processing by a SPAM detection program. One example of a SPAM detection program is MailGate Email Firewall from Tumbleweed Communications Corp. of Redwood City, Calif.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A method for controlling reception of messages from unknown sender computers in an e-mail network, comprising:
a recipient computer transmitting predetermined data to a known sender computer;
the recipient computer receiving an e-mail message intended for the recipient;
the recipient computer determining whether the received e-mail message includes the predetermined data; and
the recipient computer permitting a message to move to a known sender e-mail storage location in response to detecting that the e-mail message includes the predetermined data.

2. The method of claim 1, wherein the recipient computer is facilitated by the logical combination of processes executing on more than one computer system.
